(19) United States
(12) Patent Application Publication
(10) Pub. No.: US 2010/0306059 A1
(43) Pub. Date: Dec. 2, 2010

(54) SYSTEM AND METHOD FOR PROVIDING BANNER SERVICES

(76) Inventors: Michael B. Rettig, Atlanta, GA (US); Bill Bingham, Mableton, GA (US); James Kelley, Cumming, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/788,226

(22) Filed: May 26, 2010

Related U.S. Application Data
(60) Provisional application No. 61/181,102, filed on May 26, 2009.
(60) Provisional application No. 61/305,837, filed on Feb. 18, 2010.

(51) Int. Cl. G06F 15/16; G06Q 30/00

(52) U.S. Cl. 705/14.58; 709/203

(57) ABSTRACT

The exemplary embodiments of the present invention provide a method and system for submitting a banner from a computer system in communication with a client device at a hotspot. The method includes determining if a packet coming from a client device is one that is enabled to receive a banner, and sends a insert message to the client device if enabled to receive the banner. The method further includes associating an appropriate banner for display on the client device by a location of the client device, and sending a banner to the client device for display. The system includes an inspection means that determines if a packet coming from a client device is one that is enabled to receive a banner, and sends a insert message to the client device if enabled to receive the banner. The system further includes a banner lookup means that associates an appropriate banner for display on the client device by a location of the client device, and a banner send means that sends a banner to the client device for display.

### CROSS-REFERENCE TO RELATED APPLICATIONS

This application is claims priority to U.S. Patent Application Ser. No. 61/181,102, filed on May 26, 2009, entitled “A SYSTEM AND METHOD FOR PROVIDING HOSTPOT MARKETING”, and U.S. Patent Application Ser. No. 61/305,837, filed on Feb. 18, 2010, entitled “A SYSTEM AND METHOD FOR PROVIDING BANNER SERVICES”, both of which are incorporated by reference herein in their entirety.

### TECHNICAL FIELD

The present invention is related to technology using Internet services, and more particularly, relates to a method and system for presenting banner messages and or advertisements to wired or wireless internet users of a local business.

### BACKGROUND OF THE INVENTION

Wireless Internet (WiFi) has become a vital industry. WiFi can be used in locations ranging from personal houses to coffee shops to public transportation. Often, the WiFi is provided by the location or business in which a user is logging on with a personal computer or handheld device. A user can enter a place of business and find a WiFi connection through a “hotspot”.

There are also various ways that a business might capitalize on being a “hotspot”. A open public network is the easiest way to create a free “hotspot”. All that is needed is a Wi-Fi router. The business having the wireless router can turn off the authentication requirements, thus opening their connection, intentionally or not, for sharing by anyone in range. The advantage of this is that by providing the free Internet access, the business will drive more users in the door. The disadvantage is that access to the router cannot be controlled and the business cannot directly recoup the costs of the equipment or the network connection.

Closed network uses a hotspot management system to control the “hotspot”. This software runs on the router itself or an external computer. With this software, operators can limit access to the Internet, and they generally associate the access to a menu or to a captive portal. Utilizing this menu or captive portal, the business can collect a nominal access fee. The advantages are the ability to limit access to the Internet, but the disadvantages are downloading business specific software to access the “hotspot”.

### SUMMARY OF THE INVENTION

Embodiments of the present invention provide a method and system for submitting a banner from a computer system in communication with a client device at a hotspot.

An exemplary embodiment includes a method for submitting a banner from a computer system in communication with a client device at a hotspot. The method includes determining if a packet coming from a client device is one that is enabled to receive a banner, and sends a insert message to the client device if enabled to receive the banner. The method further includes associating an appropriate banner for display on the client device by a location of the client device, and sending a banner to the client device for display.

Another exemplary embodiment includes a system for submitting a banner at a hotspot. Briefly described in terms of architecture, one embodiment of the system, among others, is implemented as follows. The system includes an inspection means that determines if a packet coming from a client device is one that is enabled to receive a banner, and sends a insert message to the client device if enabled to receive the banner. The system further includes a banner lookup means that associates an appropriate banner for display on the client device by a location of the client device, and a banner send means that sends a banner to the client device for display.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawing and detailed description of the invention are exemplary and explanatory of preferred embodiments of the invention, and are not restrictive of the invention, as claimed.

### BRIEF DESCRIPTION OF THE DRAWINGS

FIG. 1 is a system diagram showing the basic operation of a banner system according to an example embodiment of the present invention.

FIG. 2A is a block diagram illustrating an example of a server utilizing the banner messaging system, as shown in FIG. 1.

FIG. 2B is a block diagram illustrating an example of a remote device utilizing the banner messaging system, as shown in FIG. 1.

FIG. 3 is a flow chart illustrating an example of the operation of the banner messaging system, as shown in FIG. 1.

FIG. 4 is an example of a typical transmission control protocol packet used to transport hyper text protocol to the banner messaging system, as shown in FIG. 1.

FIG. 5A is a flow chart illustrating an example of the operation of the insertion process utilized by the banner messaging system, as shown in FIGS. 1 and 2.

FIG. 5B is a flow chart illustrating an example of the operation of the packet construction for the insertion process utilized by the banner messaging system, as shown in FIGS. 1 and 2 describes the packet constructed by the insertion process 209

FIG. 6 is an example of the logical grouping of the banner files in a server database and association with these groups according to the principals of the banner messaging system of the present invention, as shown in FIGS. 1 and 2.

FIG. 7 is an example of the operation of the inserted code utilized by the insertion process utilized by the banner messaging system, as shown in FIGS. 1-3, 5 and 6.

The detailed description explains the preferred embodiments of the invention, together with advantages and features, by way of example with reference to the drawings.

### DETAILED DESCRIPTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

A “site” is a physical location that offers high speed internet access to their customers, where the banners are to be displayed on customer or site-owned computers.

“Banners” are small web pages and can be simple text, graphics or constructed from standard code that a web browser can interpret.

“Campaigns” are a logical group of sites and banners. A campaign contains a number of banners that share delivery settings, or alternatively, different delivery settings can be assigned to each banner. Campaign delivery settings can be altered to give total control over the frequency and duration of banner delivery, their prioritization, and the limits placed on them according to a variety of parameters. A campaign can be linked to a single site or multiple sites.

“Advertisers” are managers of a site or group of sites. Advertisers have control over all the content in their domain. Advertisers can manage a single site or a group of sites and post their own banners or add banner from external sources.

“External advertisers” are external sources of banners and can come from many sources.

A “Banner Management System” is comprised of web pages that allow administrators and advertisers to manage the campaigns, banners and overall operation of the banner database.

A “Banner Web Server” is a typical web server with code that makes calls to the banner management system for delivery of banners.

An “iFrame” is the webpage element that creates an online area that contains another document. The iFrame functions as a document within a document and can be floating windows or frame.

“Banner weighting” is the value in the “weight” field and influences the likelihood that a banner will be displayed within the same campaign. A banner with a weight of 3 is likely to be displayed three times as often as a banner with a weight of 1.

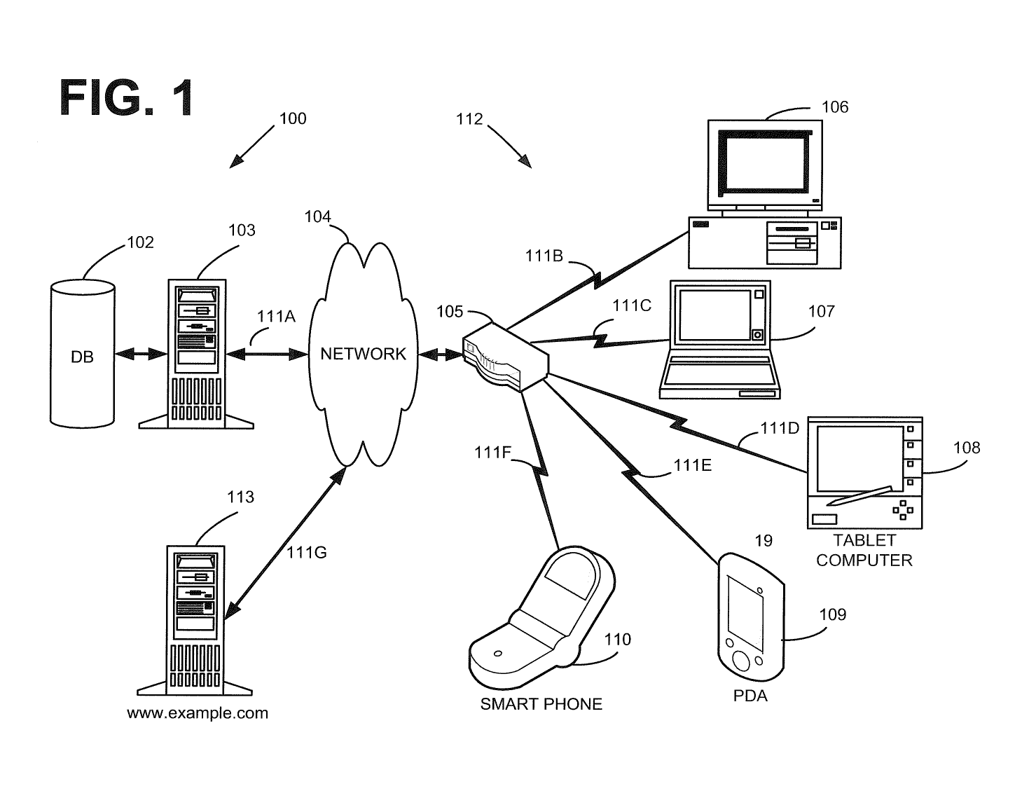

Referring now to the drawings, in which like numerals illustrate like elements throughout the several views, FIGS. 1-3 describe the operation of the banner system 100. Although any or all the processes of the banner system 100 could be implemented in a single system, embedded system or multiple systems and or placed on site, FIG. 1 depicts a typical deployment.

FIG. 1 is a block diagram illustrating an example of an exemplarily banner system 100 environment. The example of an exemplarily banner system 100 that includes computer servers 103 and 113 and the remote devices 106-110 that utilize the banner system 100 of the present invention.

Each remote device has applications and can have a local data store (not shown). Computer servers 103 and 113 contain applications and server 103 further contains a database 102 that can be accessed by remote devices 106-110 via intermittent connections 111(A-F), respectively, over network 104. The server 103 runs administrative software for a computer network and controls access to itself and database 102. The remote devices 106-110 can access the database 102 over network 104 and intermittent connections 111(A-F), such as but not limited to, a local area network (LAN), a personal area network (PAN), a campus area network (CAN), a metropolitan area network (MAN), a wide area network (WAN) or a combination of any of the above. The network and intermittent connections can include but are not limited to the Internet, a telephone line using a modem (POTS), Bluetooth, WiFi, cellular, optical, satellite, RF, Ethernet, magnetic induction, coax, RS-485, and/or other like networks. The server 103 can also be connected to the local area network (LAN) within an organization.

The structure and operation of the banner system 100 enables the server 103 and the database 102 associated therewith to handle clients more efficiently than previously known systems. Particularly, the banner system 100 of the present invention provides a manner of providing targeted banner messages to remote devices 106-110 over a network. When the remote devices 106-110 connect to the server 103, the identity and IP address information associated with the remote device are transmitted to the server to be used for delivering data (i.e., banners) to the remote device.

The remote devices 106-110 can each be located at remote sites. Remote devices 106-110 each include a remote computer device that includes a web browser. Remote computer devices include, but are not limited to, a PC, workstation, laptop, handheld computer, pocket PC, PDA, pager, WAP device, non-WAP device, palm device, tablet PCs, e-book display device, cellular, and satellite phones, printing device and/or the like.

Third party servers 113 and databases (not shown) can be accessed by the server 103 in order to obtain information for dissemination to the remote devices. Information includes banner messages to be displayed to the remote device. Data that is obtained from third party server 113 and databases can be stored on the server 103 in order to provide later access to the remote devices 106-110. It is also contemplated that for certain types of data that the remote devices 106-110 can access the third-party vendor's data directly using the network 104.

The operation of this banner system 100 depends on the ability to inspect the IP packets that are generated by the customer's computer 106-110 and look for the GET request. In order to direct these packets to the banner messaging system the local router 105 can be configured to forward the desired packets to the banner system 100.

The router 105, which often may also be a firewall, uses commonly defined standards to process the packets that are created by the remote devices 106-110. Typically these packets are sent directly to a destination web server 113 using a network 104, such as the Internet. In order to forward the desired packets to the banner system 100, the router 105 makes use of common standards based protocols.

Virtual Private Networks (VPN) are commonly used to transport network traffic from one location to another location where physical connections 111A-111F, do not exist directly between the two locations. There are various standards for implementing VPNs and they range from being un-secure to secure using encryption. Although not limited to, some examples of VPN protocols are Generic Route Encapsulation (GRE), Internet Protocol Security (IPSEC) and Point to Point Tunneling Protocol (PPTP). Regardless of the type of VPN, they all have the basic function of encapsulating a packet inside another packet to be forwarded to foreign network and then routed to the intended device. Once a connection between the remote site 112 and the banner system 100 is established filtering of packets is needed.

To understand this better, routers 105 typically route packets by the destination IP address without regard to the source IP address, packet type, source or destination port number. The banner system 100 is interested in Hypertext Transfer Protocol, commonly referred to as HTTP and not any other network protocol. The local router 105 can be configured to forward only these packets through the VPN. Typically this is done by using Policy Based Routing. Policy Based Routing does a deeper inspection of the packet than the more common routing process. Policy Based Routing, although not limited to can inspection source IP address, packet type and source and destination port numbers. By using policy based routing, the HTTP packets created by the browser 253 on the remote device 106-110 can be forwarded to the banner system 100 where they can be inspected and processed if necessary.

One of the negative effects of using VPNs is a reduction in speed. This is due to the fact that all network connections 111A-111F have a maximum transmission unit (MTU) size limit. By encapsulating one packet inside another, the payload is decreased. This can be greatly improved by not returning the reply packets back through the VPN. This can be done by using Network Address Translation (NAT). The NAT process, common to all routers today, changes the remote devices 106-110 IP address to another IP address. This is typically done as the packet leaves the out interface. In the case of a VPN, it would be the virtual interface for the VPN. By using NAT to change the remote devices 106-110 source IP address to a public IP address on the WAN side of the Router 105. When the banner system 100 de-encapsulates the packet, performs the inspection and replies the packet will return to the remote device 106-110 outside the VPN. This greatly increases the speed, being that the request is usually a very small packet as opposed to the reply, which can vary in size from small to large. This return of the packet outside of the VPN can be problem for some routers, especially ones that perform stateful packet inspection (SPI). The SPI process creates a table of open connections, their state, source addresses and port numbers, and matches the replies to the request. In the case where SPI is a problem, most routers 105 can be configured to allow these packets or even disable SPI.

Beginning with HTTP version 1.1 the host and URL information are included in the data portion of the request. By using this information, a proxy can retrieve the data being requested by the browser 253 and relay it to the remote devices 106-110. This is commonly referred to as a WEB proxy process. In order for the browser 253 to forward the request to the proxy process, the proxy process information can be configured into the client's browser 253 or is automatically delivered by a DNS in combination with a web server.

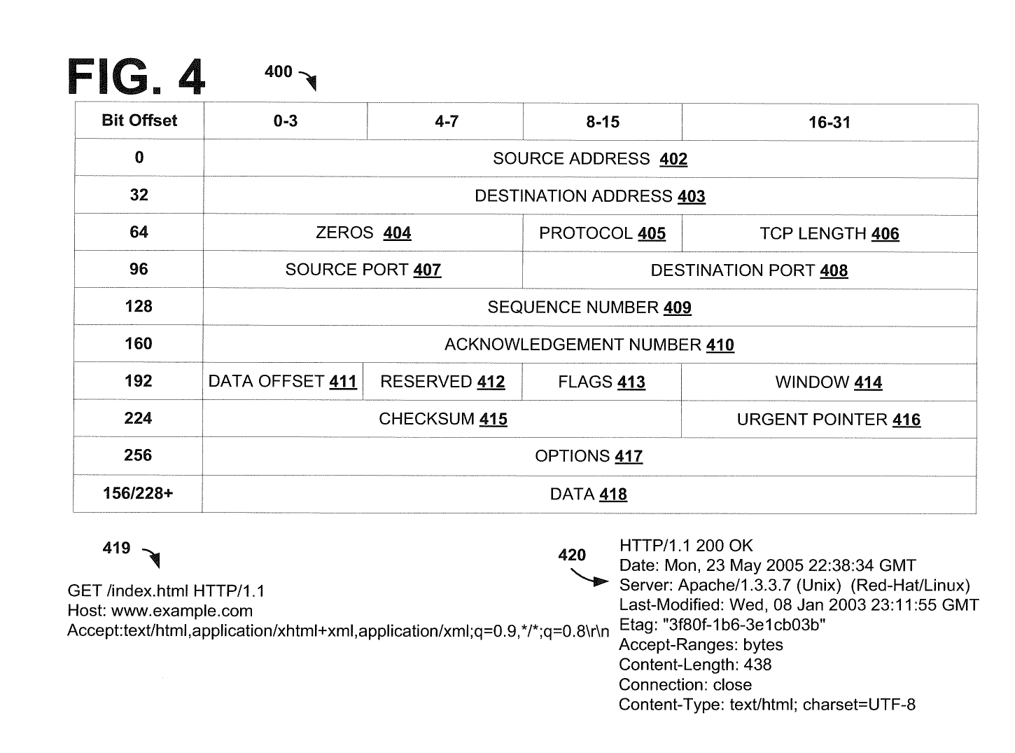

Another method to redirect the HTTP packets to the proxy process, is to configure the router 105 to perform a transparent proxy. Transparent proxy is a commonly used method to redirect HTTP packets to a proxy. By placing rules in the router 105, the destination address and port number of the HTTP packet of browser 253 on the remote devices 106-110 is changed to the IP address and port number of the proxy process. When the packet arrives, the proxy process then relays the request by using the Host and URL information found in the data portion of the packet. The data portion of the packet is herein defined in further detail with regard to FIG. 4.

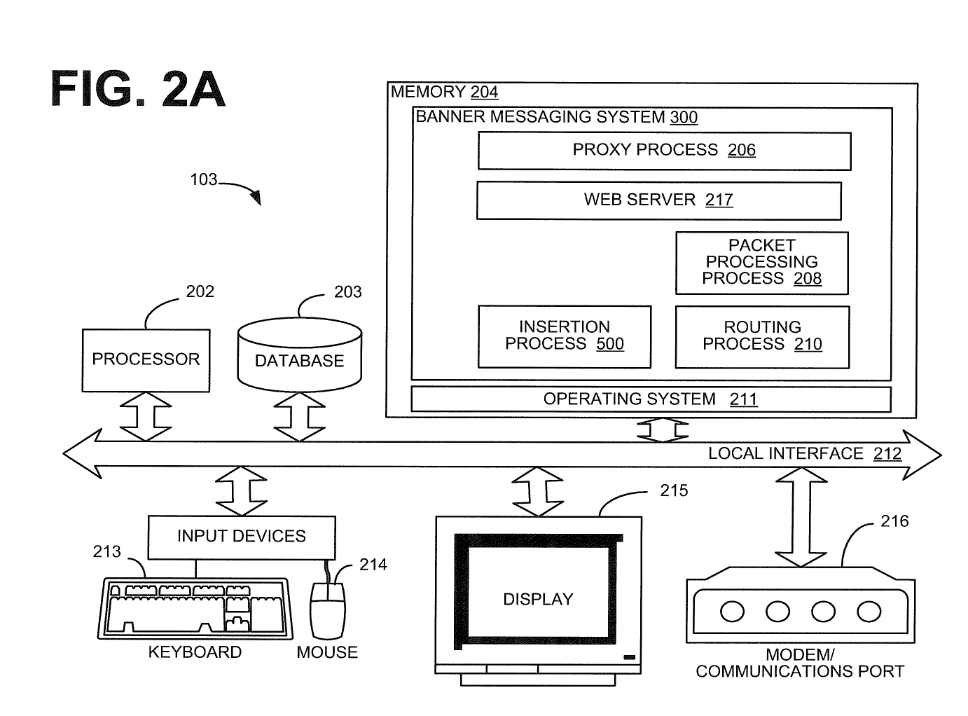

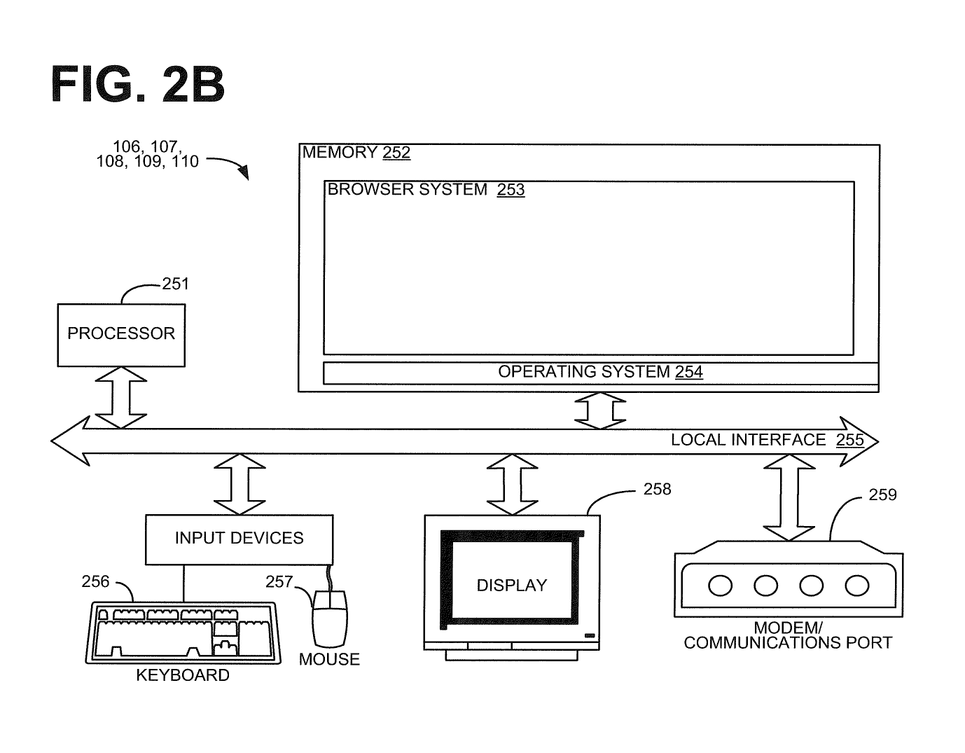

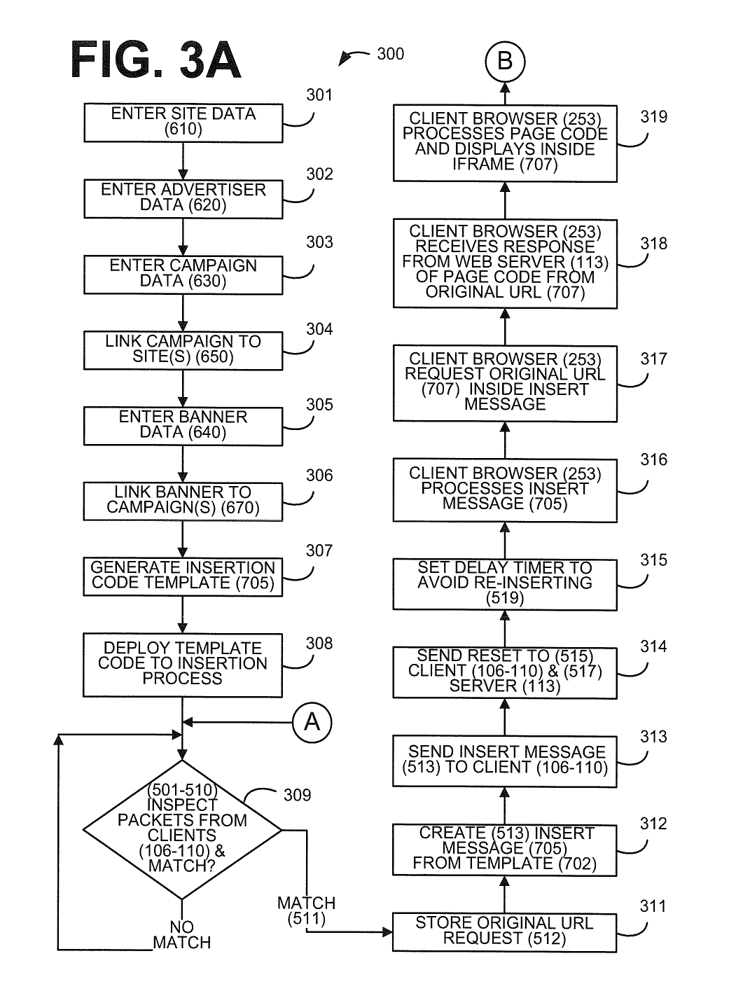

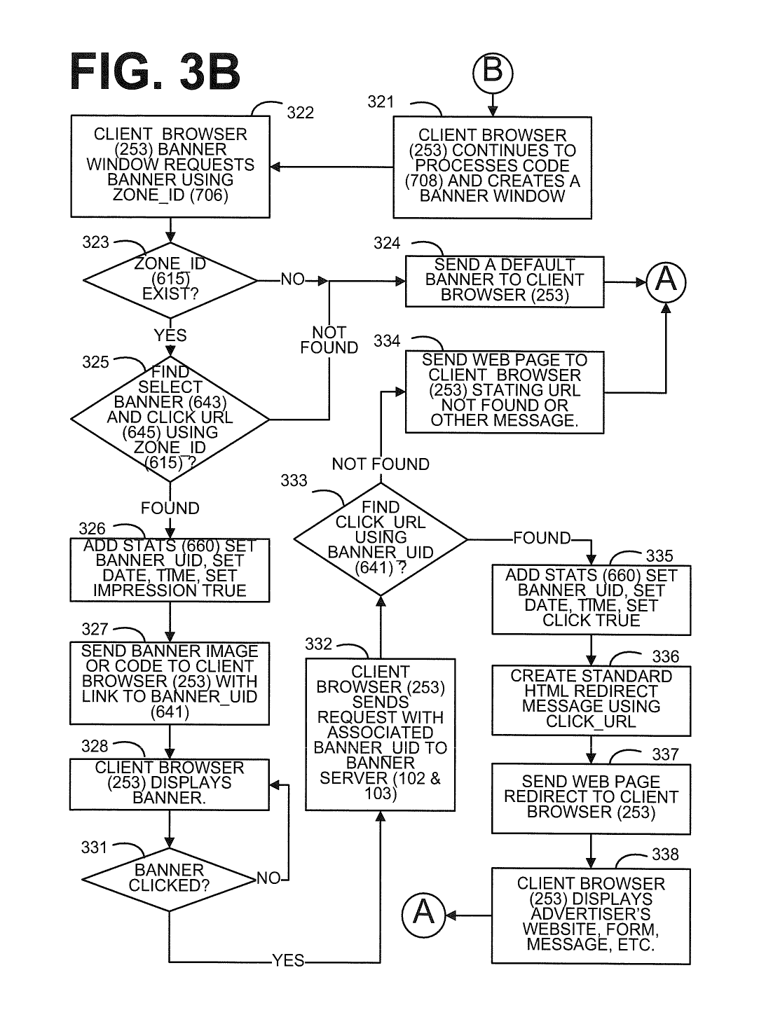

Illustrated in FIG. 2A is a block diagram demonstrating an example of server 103, as shown in FIG. 1, with the banner messaging system 300 of the present invention. Examples of server 103 include, but are not limited to, PCs, workstations, laptops, PDAs, palm devices and the like. Illustrated in FIG. 3 is an example demonstrating the remote devices 106-110 with the browser 253. The processing components of the third party server 113 are similar to that of the description for the server 103.

Generally, in terms of hardware architecture, as shown in FIG. 2A, the server 103 includes a processor 202, memory 204, and one or more input and/or output (I/O) devices (or peripherals) that are communicatively coupled via a local interface 212. The local interface 212 can be, for example, one or more buses or other wired or wireless connections, as are known in the art. The local interface 212 can be any of several types of bus structures including a memory bus or memory controller, a peripheral bus, and a local bus using any of a variety of bus architectures. By way of example, and not limitation, such architectures include industry standard architecture (ISA) bus, micro channel architecture (MCA) bus, enhanced ISA (EISA) bus, video electronics standards association (VESA) local bus, and peripheral component interconnect (PCI) bus. The local interface 43 may have additional elements, which are omitted for simplicity, such as controllers, buffers (caches), drivers, repeaters, and/or receivers, to enable communications. Further, the local interface 43 may include address, control, and/or data connections to enable appropriate communications among the aforementioned components.

The processor 202 is a hardware device for executing software that can be stored in memory 204. The processor 202 can be virtually any custom-made or commercially available processor, a central processing unit (CPU), a data signal processor (DSP) or an auxiliary processor among several processors associated with the server 103, or a semiconductor-based microprocessor (in the form of a microchip) or a macroprocessor. Examples of suitable commercially available microprocessors include, but are not limited to, the following: an 80×86, Pentium® or Core series microprocessor from Intel® Corporation, U.S.A., a PowerPC® microprocessor from IBM®, U.S.A., a Sparc™ microprocessor from Sun Microsystems®, Inc., a PA-RISC™ series microprocessor from Hewlett-Packard Company®, U.S.A., a 68xxx series microprocessor from Motorola Corporation®, U.S.A. or a Phenom™, Athlon™, Sempron™ or Opteron™ microprocessor from Advanced Micro Devices®, U.S.A.

The memory 204 can include any one or a combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 204 may incorporate electronic, magnetic, optical, and/or other types of storage media. Note that the memory 204 can have a distributed architecture, where various components are situated remote from one another, but can be accessed by the processor 202.

The software in memory 204 can include one or more separate programs, each of which comprises an ordered listing of executable instructions for implementing logical functions. In the example illustrated in FIG. 2, the software in the memory 204 includes a suitable operating system (O/S) 211 and the banner messaging system 300 of the present invention. As illustrated, the banner messaging system 300 of the present invention comprises numerous functional components including, but not limited to, the proxy process 206, packet processing process 208, insertion process 500, routing process 210 and Web server 217. The insertion process 500 is shown residing in the banner messaging system 300 residing on the server 103, however, in the preferred embodiment, the insertion process 500 would reside in memory on the router 105.

A non-exhaustive list of examples of suitable commercially available operating systems 211 is as follows: (a) a Windows/Vista operating system available from Microsoft Corporation; (b) a Netware operating system available from Novell, Inc.; (c) a Macintosh/OS X operating system available from Apple Computer, Inc.; (e) an UNIX operating system, which is available for purchase from many vendors, such as but not limited to the Hewlett-Packard Company, Sun Microsystems, Inc., and AT&T Corporation; (d) a LINUX operating system, which is freeware that is readily available on the Internet; (e) a run time Vxworks operating system from WindRiver Systems, Inc.; or (f) an appliance-based operating system, such as that implemented in handheld computers or personal data assistants (PDAs) (such as for example Symbian OS available from Symbian, Inc., PalmOS available from Palm Computing, Inc., Windows CE available from Microsoft Corporation, and Chrome OS available from Google).

The operating systems 211 controls the execution of other computer programs, such as the banner messaging system 300, and provides scheduling, input-output control, file and data management, memory management, and communication control and related services. However, it is contemplated by the inventors that the banner messaging system 300 of the present invention is applicable on all other commercially available operating systems.

The banner messaging system 300 can be a source program, executable program (object code), script, or any other entity comprising a set of instructions to be performed. When the banner messaging system 300 is a source program, the program is usually translated via a compiler, assembler, interpreter, or the like, which may or may not be included within the memory 204, so as to operate properly in connection with the O/S 211. Furthermore, the banner messaging system 300 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices can include input devices, for example but not limited to, a mouse 214, keyboard 213, scanner (not shown), microphone (not shown), etc. Furthermore, the I/O devices can also include output devices, for example but not limited to, a printer (not shown), display 215, etc. Finally, the I/O devices can further include devices that communicate both inputs and outputs, for instance but not limited to, a NIC or modulator/demodulator 216 (for accessing remote devices, other files, devices, systems, or a network), a radio frequency (RF) or other transceiver (not shown), a telephonic interface (not shown), a bridge (not shown), a router (not shown), and/or the like.

If the server 103 is a PC, workstation, intelligent device or the like, the software in the memory 204 can further include a basic input output system (BIOS) (omitted for simplicity). The BIOS is a set of essential software routines that initialize and test hardware at startup, start the O/S 49, and support the transfer of data among the hardware devices. The BIOS is stored in some type of read-only memory, such as ROM, PROM, EPROM, EEPROM or the like, so that the BIOS can be executed when the server 103 is activated.

When the server 103 is in operation, the processor 202 is configured to execute software instructions stored within the memory 204, to communicate data to and from the memory 204, and generally to control operations of the server 103 pursuant to the software. The banner messaging system 300 and the O/S 211 instructions are read, in whole or in part, by the processor 202, perhaps buffered within the processor 202, and then executed.

When the banner messaging system 300 is implemented in software, as is shown in FIG. 2A, it should be noted that the banner messaging system 300 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, propagation medium, or other physical device or means that can contain or store a computer program for use by or in connection with a computer related system or method.

More specific examples (a nonexhaustive list) of the computer-readable medium can include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched (as in paper tape, punched cards, etc.), as the program can be electronically captured, via for instance optical scanning of the paper or other medium, then compiled, interpreted or otherwise processed in a suitable manner if necessary, and then stored in a computer memory.

In an alternative embodiment, where the banner messaging system 300 is implemented in hardware, the banner messaging system 300 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Illustrated in FIG. 2B is a block diagram demonstrating an example of functional elements in the remote devices 106-110 that enable access to the banner messaging system 300 of the present invention, as shown in FIG. 2. The remote devices 106-110 provide access to the internet using a browser 253. The remote devices 106-110 enable a user to generate request for web pages. Some of the requested pages are directly typed into the address field of most browsers, Internet Explorer, Firefox, Chrome, etc. 253). Other requests are generated by the code in the web pages received from a clicked link or manual entry. The majority of the requests are in the form of a GET. The GET Requests a request for a specific resource, ASCII data, WEB page data (e.g. HTML), XML or other type of formatted data, images, JavaScript Code and any other code a browser 253 can interpret.

The software in memory 252 can include one or more separate programs, each of which comprises an ordered listing of executable instructions for implementing logical functions. In the example illustrated in FIG. 2B, the software in the memory 252 includes a suitable operating system (O/S) 254 and the browser 253. As illustrated, the remote devices 106-110 each include components that are similar to components for server 103 described with regard to FIG. 2A. Hereinafter, the remote devices 106-110 is referred to as the client device 106 for the sake of brevity.

### Banner Messaging System 300

FIG. 3 is a flow chart illustrating an example of the operation of the banner messaging system 300, as shown in FIGS. 2A and 2B. The banner messaging system 300 eliminates the need for any special client software to be installed and makes use of the built-in features of typical web browsers. In an example embodiment, this is accomplished by inserting standards-based browser code by means of monitoring and creating an impersonated response of the original web server request with desired code or content modifications. Any process descriptions or blocks in FIG. 3. should be understood as representing modules, segments, or portions of code which include one or more executable instructions for implementing specific logical functions or steps in the process, and alternate implementations include, where the functions may be executed out of order from that shown or discussed, including substantially concurrently or in reverse order, depending on the functionality involved. In addition, the specific logical functions are illustrated in one flow chart, however, these functions in one embodiment, are performed by different pieces of equipment. However, it is understood that these logical functions could reside all in one location or in a distributed network, as shown in FIG. 1.

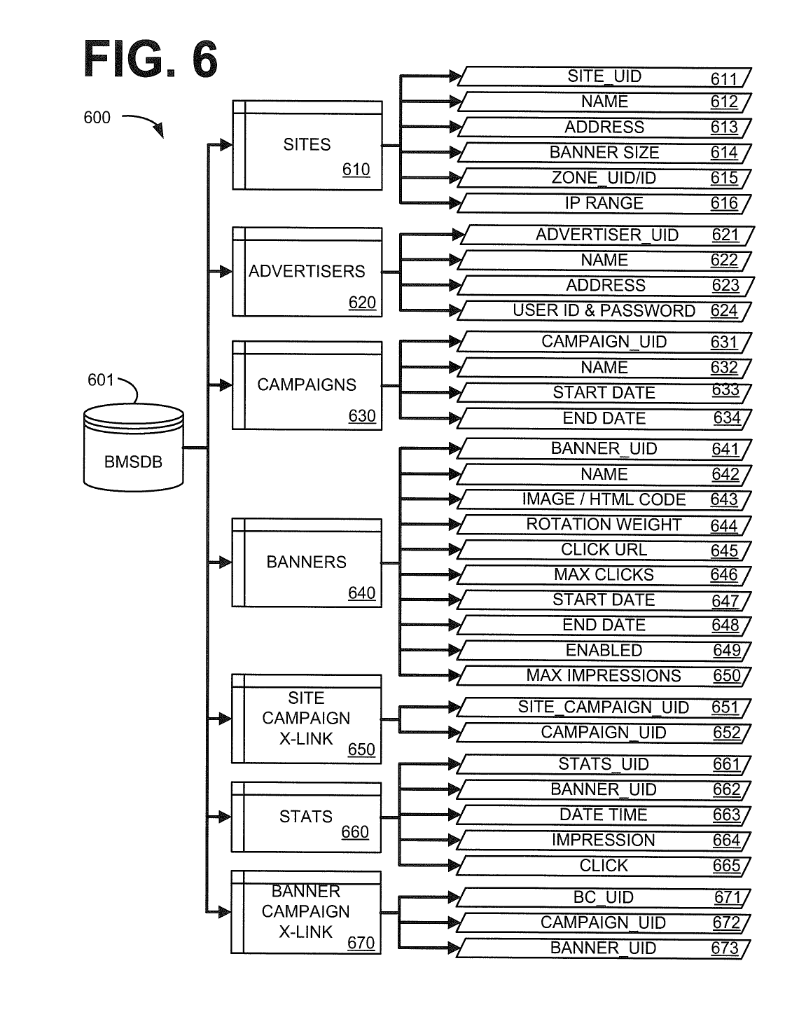

First, the banner data is configured in steps 301-307. In one embodiment, this banner data is input to database 601, which is herein defined in further detail with regard to FIG. 6. In the preferred embodiment, database 601 resides on server 103, however, it is understood that this data may also reside on a router 105. While the banner messaging system 300 is discussed herein with regard to FIG. 3 is one process, it could be broken up into separate processes. In an alternative embodiment, the banner configuration occurring at steps 301-307 could be completed in a separate banner configuration process.

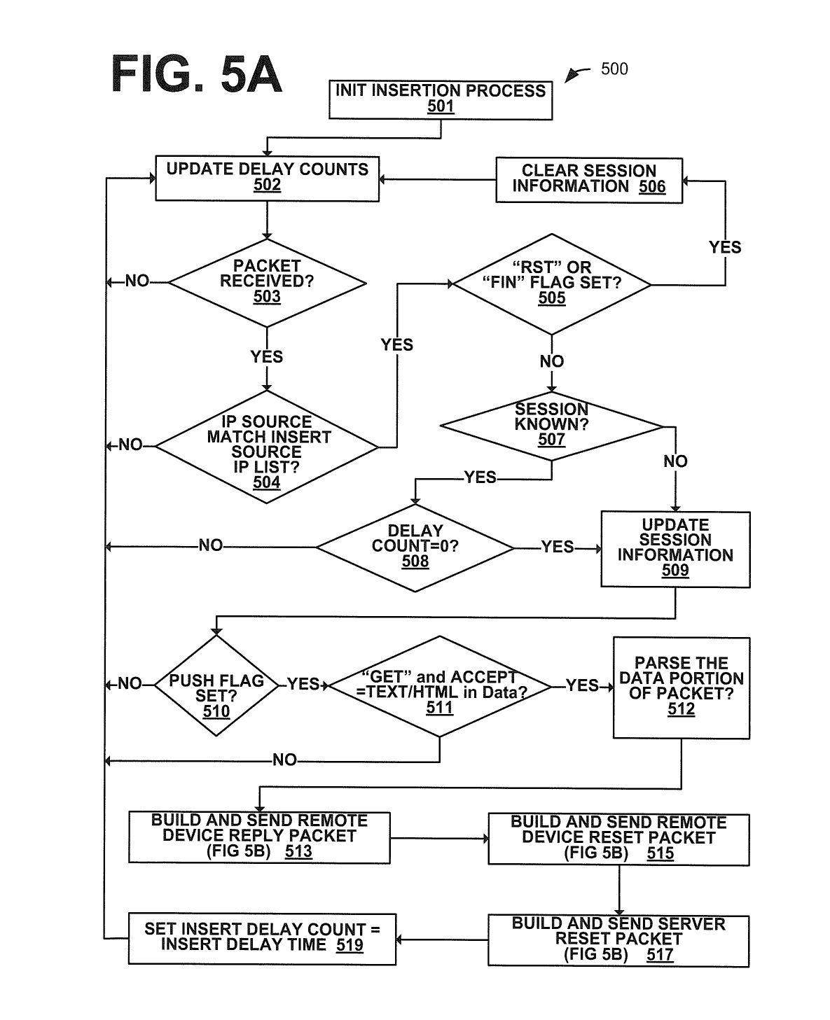

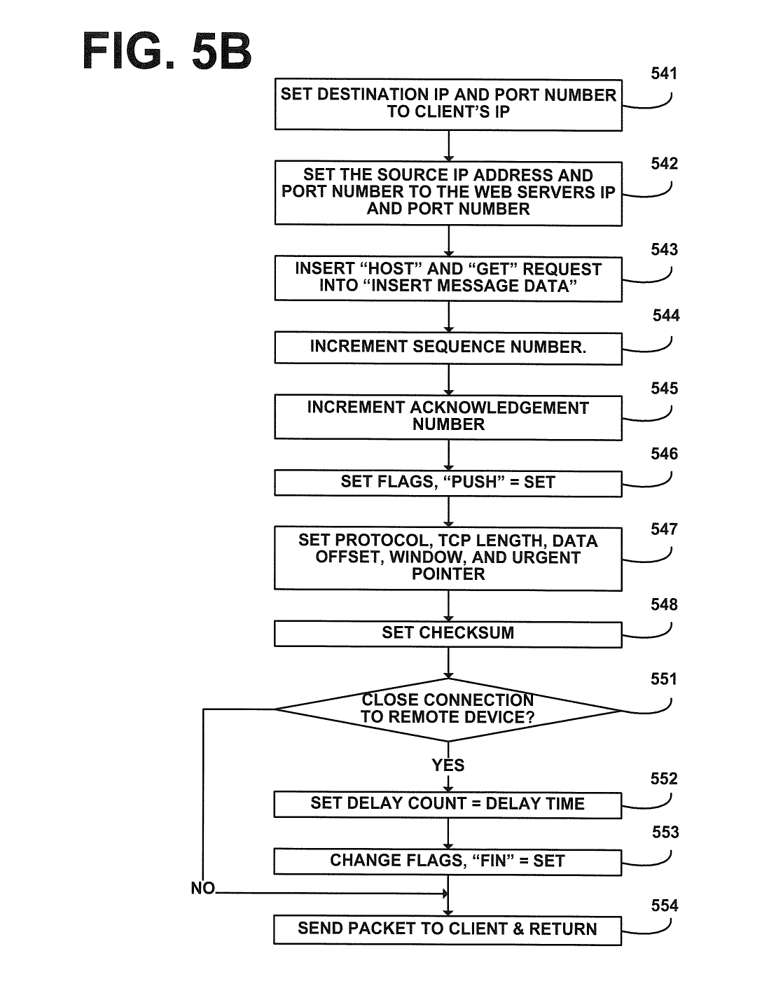

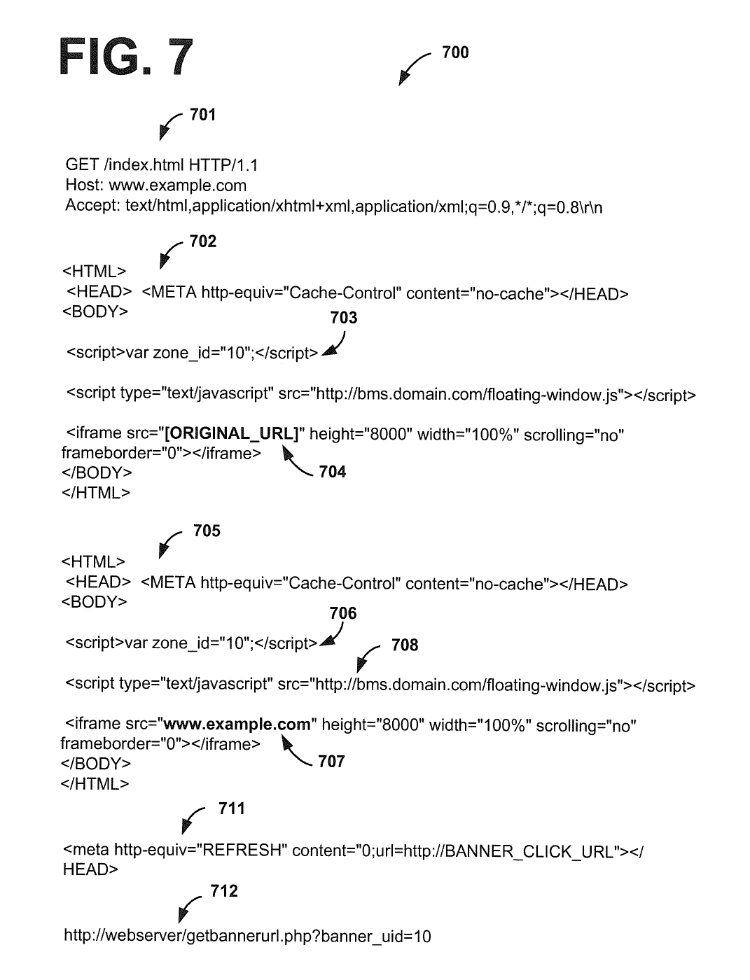

At step 307, the insertion code template is generated. The insertion code template is herein defined in further detail with regard to FIG. 7. At step 308, the template code created at step 307 is deployed to the insertion process. Herein defined in further detail with regard to FIGS. 5A and 5B.

Next steps 309-315 perform an insertion process that is herein defined in further detail with regard to FIGS. 5A and 5B. At step 309, TCP packets coming from the client device 106 are inspected to see if the source IP address matches an address in the insert source IP address list. If the source IP address does not match an address in the insert source IP address list, then the banner messaging system 300 waits to receive the next TCP packet at step 309. However, if it is determined at step 309 that a TCP packet has a source IP address that matches an address in the insert source IP address list, then original URL request is stored at step 311.

At step 312, an insert message is created from the insertion code template. The insertion code template is herein defined in further detail with regard to FIG. 7. At step 313, the insertion message created from the template is sent to the client device 106.

At step 314, a reset message is sent to the client device 106 and server 113 receiving the URL request. At step 315, a delay timer is set to avoid resending the insert message to quickly to the same client device 106. In one embodiment, steps 309-315 are performed on the router 105. However, in alternative embodiments, these functional steps can be performed on any device that is in position to intercept data packets coming from the client device 106.

At step 316, the client browser 253 processes the insert message sent at step 313. At step 317, the client browser requests the original URL inside the insert message. At step 318, the client browser receives a response from Web server 113 of the page code from the original URL. This insert message and page code is herein defined in further detail with regard to FIG. 7. At step 319, the client browser processes the page code and displays the page code inside and I-frame. At step 321, the client browser continues to process the code and create the banner window. At step 322, the client browser banner window requests a banner for insertion in the banner window using the zone_UID/ID 615. the zone_UID/ID 615 is herein defined in further detail with regard to FIG. 7.

Steps 323-327 of the banner messaging system 300 preferably are performed on the server 103. At step 323, the banner messaging system 300 checks the zone_UID/ID 615 to see if it exists. The zone_UID/ID 615 is herein defined in further detail with regard FIG. 6. If it is determined that the zone_UID/ID 615 does not exist, then the banner messaging system 300 since default banner to the client browser at step 324 and then returns to step 309.

However, if it is determined at step 323 that the zone_UID/ID 615 does exist and database 601, then the banner messaging system 300 attempts to find the selected banner and click_URL using the zone_UID/ID 615 at step 325. If it is determined at step 325 that the selected banner or click_URL is not found, then the banner messaging system 300 since the default banner to the client browser at step 324 and returns to step 309. However, if the selected banner and click_URL is found at step 325, then the banner statistics for the selected banner are updated, including setting the banner_UID, date, time and then setting the impression the true, at step 326. At step 327, the banner image or code is sent to the client browser 253 with a link to the banner_UID.

At step 328, the client browser 253 displays the banner sent at step 327. At step 331, the client browser 253 then determines if the banner was clicked on or selected. If it is determined that the banner is not clicked upon or selected, then the banner messaging system 300 returns to redisplay the banner at step 328. However, if it is determined at step 331 that the banner was clicked on or selected, then the client browser 253 sends a request with the associated banner_UID to the banner server 103, at step 332.

At step 333, the banner messaging system 300 then attempts to find the click_URL using the banner_UID. If it is determined that the click_URL using the banner_UID is not found, then the banner messaging system 300 sends a webpage to the client browser 253 beating that the URL is not found or some other warning notice at step 334. However, if it is determined at step 333 that the click_URL using the banner_UID is found, then the banner statistics for the selected banner are updated, including setting the banner_UID, date, time and then setting the click to true, at step 335. At step 336, a standard HTML redirect message is created using the click_URL. At step 337, the webpage redirect message is sent to the client browser 253. Steps 333-337 of the banner messaging system 300 preferably are performed on the server 103.

At step 338, the client browser displays the advertiser's website form message and then returns to step 309.

### Insertion Process 209

FIG. 4 describes an example of a typical transmission control protocol packet used to transport hyper text protocol to the banner messaging system 300, as shown in FIG. 2. In order to better understand the insertion process 209, it is helpful to understand the transmission control protocol (TCP). Whereas IP deals only with packets, TCP enables two hosts to establish a connection and exchange streams of data. TCP guarantees delivery of data and guarantees that packets will be assembled in the same order in which they were sent. The guarantee of data delivery and sequence is done by using a sequence number 409. An initial sequence number 409 is agreed during the three way handshake process between the host and a server.

When a remote device 106-110 accesses a web server 113, the browser 253 generates a sequence of packets. Initially these packets are to set up the connection and essentially building a virtual pipe between the remote device 106-110 and a web server 113. Additional packets contain request and the reply from the web server and messaging to close the connection when done are exchanged. The process constructing these additional packets is herein defined in further detail with regard to FIG. 5B. The HTTP request and the HTTP replies are in plain text and can be read and parsed into the distinct messages that a web server would normally process.

As TCP packets are sent the sequence number 409 is increased and the received packets are acknowledged 410 by their sequence number 410. By doing this the receiving host can determine missing segments and out of sequence packets and reassemble out of sequence packets. The flaw in the process is that the sequence number 409 is simply calculated by adding the number of bytes of data 418 to the last sequence number 409.

By exploiting the sequence number 409 simplicity the insertion process 209 can insert its own packets into the TCP conversation before the intended destination can respond. The receiving system will process them as if they were sent by the intended destination.

FIG. 5A describes an example the insertion process 209 and FIG. 5B describes an example the process for packet construction by the insertion process 209. The insertion process 209 requires that it be virtually or physically in the path of the IP packets. The initialization step 501 of the insertion process 209 requires a few parameters to be configured. The insert source IP address list is set to the remote devices 106-110 IP address to be monitored. The insert destination port 408 is typically set to the well know port number for HTTP, such as for example, port 80. The insert delay timer, a global setting, is set to the amount of time after an insert, so that the insertion process 209 is delayed before attempting another insert on this source IP address.

Every time the insertion process 209 cycles around, the delay counts are updated by the decrementing the amount of time passed since the last cycle until the count reaches zero, at step 502.

Afterwards the insertion process 209 checks for a received TCP packet at step 503. If it is determined at step 503 that a TCP packet was not received, then the insertion process returns to step 502. Once a TCP packet is received, the source IP address is compared against the insert source IP address list, at step 504. If it is determined at step 504 that the source IP address does not match a in the insert source IP address list, then the insertion process returns to step 502. At step 505, it is determined if the “RST” or “FIN” flag 413, which indicates a closing connection, is set. If it is determined that the “RST” or “FIN” flag 413, which indicates a closing connection, is set, then the state information for this session is cleared at step 506 and the insertion process returns to step 502.

Otherwise, if it is determined that the “RST” or “FIN” flag 413, does not indicate a closing connection, then this session is compared to the known sessions at step 507. If it is determined that the session is not known, then the insertion process skips to step 509. However, if it is determined that the session is known, then it is determined if the delay count is equal zero, at step 508. If it is determined that the delay count is equal to zero, then the insertion process 500 skips to step 509. However, if it is determined that the delay count is not equal to zero, then the insertion process 500 returns to step 502 to update the delay count.

At step 509, the sessions information is added. Next, the PUSH Flag 413 which indicates that the packet is sending data 418, is checked at step 510. If it is determined that the push flag is not set, then the insertion process 500 returns to step 502 to update the delay count. However, if it is determined that the push flag is set, then the data 418 portion of the packet 400 is inspected, at step 511, for an HTTP “GET” and “ACCEPT”=“html, xhtml, etc”. If either “GET” or “ACCEPT” is found, then the packet data 418 is parsed at step 512 into the HTTP values 419. After parsing, a response packet is constructed at step 513 using the remote device's 106-110 address and port number 408 for this session in the destination address and port portion of the packet 403 & 408. The process for packet construction is herein defined further detail with regard to FIG. 5B. The source address 402 and port number 408 are set to the server or devices address of the insertion process 209 to the web server's 113 address the remote device was originally connected to.

The insert message data contains the response that the remote devices 106-110 will receive. It is composed of standard HTML, JavaScript or any other code a browser 253 can interpret. The insert message data also contains place holders that are filled by the data parsed from the remote devices 106-110 HTTP “GET” Request (419). Typically the variables specify where to add the HOST and the GET message to the insert message data. The acknowledgment 410 and sequence 409 numbers are calculated and set in the response packet. The checksum 415 is calculated and the packet is sent 514 to the remote device 106-110.

At this point the original connection between the remote device 106-110 and the web server 113 is de-synchronized. If the session is left open it will create an acknowledgement 410 storm between the remote devices 106-110 and the web server 113. Although eventually the session will be closed due to the lack of being able to re-synchronize the insertion process 209 should close the connection in both directions.

To close the connection to the remote device 106-110 a packet is constructed and sent at step 516 with the “FIN” flag 413 set, acknowledgement 410, synchronization 409 numbers are aligned and checksum 415 are calculated and the packet is sent 516 to the remote device 106-110 and the session is closed. The process for packet construction is herein defined further detail with regard to FIG. 5B.

To close the connection to the web server (113) the process is basically the same. A packet is constructed 517 with the “FIN” flag 413 set, acknowledgement 410, synchronization 409 numbers are aligned and checksum 415 calculated and the packet is sent 518) to the web server 113 and the session is closed. The process for packet construction is herein defined further detail with regard to FIG. 5B.

The insertion process 209 is now complete and the browser 253 on the remote device 106-110 will now start processing the response 420. The browser 253 processing the response created by the insertion process 209 will generate additional packets what would normally be of interest to the Insertion process 209. In order to eliminate the possibility of re-inserting while the remote device 106-110 is processing a previous insert the delay count value is set to the insert delay time 519.

FIG. 5B describes an example the process for packet construction by the insertion process 209. The destination IP address 403, and destination port 408 is set to the client browser 253 on remote device 106-110 at step 541. The destination port 408 is typically set to the well known port number for HTTP, such as for example, port 80. At step 542, the source IP address and port number are set to the Web server 113 IP address and port number. At step 543, the “HOST” and “GET” request are inserted into the insert message data. At steps 544 and 545, the sequence number and acknowledgment number are incremented. The sequence number is used to indicate the next packet in the sequence, and the acknowledgment number is used to confirm that a packet was received. At step 546, the push flag 413 is set indicates that the packet is sending data 418. Next, the protocol 405, TCP length 406, data offset 411, window 414, and urgent pointer 416 are set, at step 547. At step 578, the checksum 415 is set.

At step 551, it is determined if the packet is being constructed in order to close a connection to a remote device. If it is determined that the packet being constructed is not too close a connection to a remote device, then the packet construction process skips to step 554. However, if it is determined at step 551 that the packet is being constructed too close a connection to a remote device, then the delay count is set equal to delay time at step 552. At step 553, flags 413 is set to “FIN” to indicate that the connection with the remote device is to be closed.

At step 554, the packet constructed is sent to the client.

### Banner Messaging System Database 601

FIG. 6 is an example of the logical grouping of the banner files in a banner messaging system database 601 and association with these groups according to the principals of the banner messaging system 300 of the present invention, as shown in FIGS. 1 and 2. The banner messaging system 300 is comprised of server 103 with a database 102 of sites 610, advertisers 620, campaigns 630 and banners 640. A method of linking 650 campaigns to sites, banners to campaigns 670. The banners 640 can be managed by advertisers 620 and can add or delete the order and control rotation weighting 644 of the banners as desired.

Each site is entered in the banner messaging system 300 and is assigned a site unique identifier 611. The site unique identifier 611 is used as a key item to associate the campaigns 630 to a specific site 610 by using the SITE CAMPAIGN XLINK 650 table, the site unique identifier 611 and the campaign unique identifier 631. Once a physical site is installed, the system administrator associates the site to a campaign and creates a user login and password for advertiser 620. Once the login is created, the advertiser has control of the banners and messages that are displayed in their domain. If desired, the advertiser can also provide access for others. This option requires a “catch all” sub-domain to be created by the administrator. This sub-domain (i.e., advertiser.domain.com) allows the advertiser an easy way to provide a user-friendly portal for others to buy advertising campaigns and post them within their domain. The advertiser's domain can consist of many campaigns 630. For instance campaign “A” can be for sites 1-10, campaign “B” can be for sites 11-20, etc. Campaigns can also overlap sites. For example, campaign “C” could consist of sites 1-5 and 16-20, so that sites 1-5 are in campaigns “A” and “B” and sites 16-20 are in campaigns “B” and “C”.

Banner code can be simple text, graphics or any code (html, JavaScript, etc) that a browser 253 can interpreter and process. Banners 640 can come from many sources, but are typically come from advertisers and external advertisers. One method for external advertisers to add their banners is to use an ecommerce web site. By using the sub-domain method above that collects scheduling information, date and time, and payment information, and that allows a customer to upload graphics or code to be presented. Another method used is an external advertiser portal (i.e. web site banner aggregators) to add banners. Once banners are submitted they are entered into the banner table 640) and are assigned a banner unique identifier 641. The banner unique identifier 641 is used to associate the banners 640 to campaigns 630, and to track the statistics 660, impression count 664, click count 665 and date time 663 of the event.

Banners can be enabled or disabled 649, and also can be limited in the number of max impressions 650, clicks 646, and start 647/stop 648 scheduling. The banner can also have a click_URL 645 associated to it. This click_URL 645 is stored in the database 601 for the banner messaging system 300. An alternate URL that is generated by the banner messaging system 300 as a key to increment stats. The alternate URL points to the web server 217 in the banner messaging system 300, with specific parameters appended to indicate the banner image or code 643 that was clicked. When the alternate URL is clicked the request is sent to the web server 217 in the banner messaging system 300 and the appended parameters are used as a reference to the banners click_URL 645. The banner messaging system 300 retrieves the banners' original click_URL 645 and responds to the browser 253 on the remote device 106-110 with a HTTP Redirect. The HTTP Redirect to the click_URL 645 instructs the browser 253 on the remote device 106-110 to connect to the banner URL 645. This method allows the date time 663, click count 665, and statistics 660 to be collected.

In one embodiment, the banner messaging system 300 normally selects the banner 640 to be displayed by using round-robin method, which simply selects the next Banner 640 up for display within the pool of available banners 640. This can be changed by modifying the rotation weight 644 of the banner 640. By adding to the rotation weight 644, the banner will be displayed more frequently in relation to the remaining banners in its campaign 630.

When the inserted code is processed by the browser 253 on the remote device 106-110, a request for a banner image code 643 is made to the web server 217 on the banner messaging system 300. The web server 217 accesses the database 601 for the banner messaging system 300 and by using the zone_UID/ID 615 as the key, returns the next banner 640 which is associated to the campaign 630 for this site 610.

### Inserted Code

FIG. 7 describes one method of displaying a banner message by using inserted base code. The inserted code 702 can be any code that the browser 253 can interpret.

The request 701 is intercepted by the insertion process 209. The insertion process 209 parses the request 701 and the typical for the HOST and GET are stored variables. The zone_UID/ID 615, the key to the banner 640 to be displayed, can be hard coded 703 in the inserted code 702. The zone_UID/ID 615 can also be queried from the database 601 of the banner messaging system 300 by using the source IP address of the remote device 106-110, which the web server 217 can provide, and the site IP range 616. The insert code 702 is copied and searched for variables 704. The variables 704 are replaced by their respective values from the parsing of the original request. The resulting code 705 is an assembly of the banner message 706 and referral 707 to the original request.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

It should be emphasized that the above described embodiments of the present invention, particularly, any “preferred” embodiments, are merely possible examples of implementations, merely set forth for a clear understanding of the principals of the invention. Many variations and modifications may be made to the above described embodiments of the invention without departing substantially from the spirit and principles of the invention. All such modifications and variations are intended to be included herein within the scope of this disclosure and the present invention and protected by the following claims.

1. A system for submitting a banner at a hotspot, comprising:
a computer system comprising a storage medium readable by a processing circuit and storing instructions for execution by the processing circuit for submitting a banner, the computer system further comprising:
a inspection means that determines if a packet coming from a client device is one that is enabled to receive a banner, and sends a insert message to the client device if enabled to receive the banner;
a banner lookup means that associates an appropriate banner for display on the client device by a location of the client device; and
a banner send means that sends a banner to the client device for display.

2. The system of claim 1, wherein the client device has at least one banner associated with a location.

3. The system of claim 2, wherein the at least one banner is associated with an advertiser.

4. The system of claim 3, wherein the advertiser can add or delete the at least one banner associated with the advertiser.

5. The system of claim 1, further comprising:
a statistics means that collects statistics for the banner sent to the client device.

6. The system of claim 1, further comprising:
a banner scheduling means that determines a plurality of banners that are available to be sent to the client device.

7. The system of claim 6, wherein the banner scheduling means determines which of the plurality of banners are available by date.

8. The system of claim 6, wherein the banner scheduling means determines which of the plurality of banners are available by number of times the banner was sent to the client device.

9. A method for submitting a banner at a hotspot from a computer system in communication with a client device, wherein the computer system comprises a storage medium readable by a processing circuit and storing instructions for execution by the processing circuit for performing said method, comprising:
determining if a packet coming from a client device is one that is enabled to receive a banner, and sends an insert message to the client device if enabled to receive the banner;
associating a appropriate banner for display on the client device by a location of the client device; and
sending a banner to the client device for display.

10. The method of claim 9, wherein the client device has at least one banner associated with a location.

11. The method of claim 10, wherein the at least one banner is associated with an advertiser.

12. The method of claim 11, wherein the advertiser can add or delete the at least one banner associated with the advertiser.

13. The method of claim 9, further comprising:
collecting statistics for the banner sent to the client device.

14. The method of claim 9, further comprising:
determining a plurality of banners that are available to be sent to the client device.

15. The method of claim 14, further comprising:
determining which of the plurality of banners are available by date.

16. The method of claim 14, further comprising:
determining which of the plurality of banners are available by number of times the banner was sent to the client device.

17. A remote device for inserting code into an established communication stream between two computers, comprising a storage medium readable by a processing circuit and storing instructions for execution by the processing circuit for inserting code into an established communication stream between two computers, the remote device further comprising:
a inspection module that determines by a source IP address if a packet coming from a client device is one that is enabled to receive a banner;
a template creation module that creates an insertion message for inserting the code into the communication stream between the two computers;
a template send module that sends the insertion message to a first computer of the two computers; and.
a reset module that sends a reset message to a second computer of the two computers that creates a de-synchronized communication stream between the two computers.

18. The remote device of claim 17, further comprising:
a configuration module that configures a plurality of banners available to be sent to the client device.

19. The remote device of claim 17, further comprising:
a statistics module that collects statistics for the code sent to the first computer.

20. The remote device of claim 17, further comprising:
a decoupling module that closes the de-synchronized connections between systems.
